(19) United States
(12) Patent Application Publication
(10) Pub. No.: US 2017/0277287 A1
(43) Pub. Date: Sep. 28, 2017

(54) COMPUTING DEVICE CONTACT MITIGATION

(71) Applicant: HEWLETT-PACKARD DEVELOPMENT COMPANY, LP., HOUSTON, TX (US)

(72) Inventor: STEPHEN DANIEL STOLL, HOUSTON, TX (US)

(21) Appl. No.: 15/329,887

(22) PCT Filed: Sep. 26, 2014
(86) PCT No.: PCT/US2014/057699

§ 371 Date: Jan. 27, 2017

(51) Int. Cl. G06F 3/0354; G06F 3/023

(52) U.S. Cl. CPC G06F 3/03547; G06F 3/0233

(57) ABSTRACT

In one example implementation, a process includes detecting depression of one of a first set of alphanumeric keys for less than a threshold time period, and, in response, triggering keyboard-based accidental contact mitigation (KBACM) with respect to a touchpad for a time period. The process further includes detecting depression of one of a second set of alphanumeric keys for less than the threshold time period, and, in response, not triggering KBACM with respect to the touchpad.

### BACKGROUND

In today's marketplace, there are various types of computing devices. For example, there are notebooks, desktops, workstations, thin clients, tablets, and smartphones, to name a few. These computing devices are used for a variety of tasks ranging from complex animation design to simple web surfing.

Depending on the user's task and computing device type, different input approaches may be utilized. For example, a user may utilize mouse input, keyboard input, touchpad input, touchscreen input, and/or voice input. In some computing devices like notebook computers, multiple input approaches may be utilized. For example, a user may have the option of utilizing mouse input, keyboard input, or touchpad input, depending on the user's preference.

### BRIEF DESCRIPTION OF THE DRAWINGS

Examples are described in the following detailed description and in reference to the drawings, in which:

FIG. 1 depicts an example computing device in accordance with an implementation;

FIG. 2 depicts an example keyboard configuration in accordance with an implementation:

FIG. 3 depicts an example process flow diagram for computing device operation in accordance with an implementation;

FIG. 4 depicts an example process flow diagram for computing device operation in accordance with another implementation; and

FIG. 5 depicts an example computing device in accordance with another implementation.

### NOTATION AND NOMENCLATURE

Certain terms are used throughout the following description and claims to refer to particular system components. As one skilled in the art will appreciate, technology companies may refer to components by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection unless specified otherwise. Thus, if a first device couples to a second device, that connection may be through a direct electrical or mechanical connection, or through an indirect electrical or mechanical connection via other devices and connections. Furthermore, the term keyboard-based accidental contact mitigation or “KBACM” is intended to mean a form of accidental contact mitigation where touchpad functionality (e.g., triggering cursor movement) is disabled for a period of time when depression of an alphanumeric key is detected.

### DETAILED DESCRIPTION

As discussed above, there are numerous input approaches associated with computing devices (e.g., mouse input, keyboard input, touchpad input, touchscreen input, and/or voice input). In some instances, utilizing one input approach may unintentionally interfere with another input approach. For example, when a user is typing on a notebook keyboard, the user may accidentally contact the notebook touchpad. This contact may unintentionally trigger actions such as mouse movement, and thereby interfere the user's typing task. To help eliminate such occurrences, some computing devices implement accidental contact mitigation (ACM) functionality such as palm rejection. In general, ACM reduces the incidence of unwanted touchpad behavior due to accidental touchpad touches and clicks.

One particular type of ACM is keyboard-based accidental contact mitigation (KBACM). KBACM is a strict form of ACM where touchpad functionality is disabled when keyboard key depression is detected. Hence, if a user is typing and KBACM is triggered, unintentional touchpad touches will not trigger actions such as cursor movement. In most situations, this result is appreciated by users because it mitigates unintentional actions. In some situations, however, this result is not appreciated. For example, in some situations, the user would like to utilize touchpad functionality at the same time as keyboard functionality. For example, when a user is participating in a gaming activity (e.g., playing gaming software such as World or Warcraft), the user may desire simultaneous keyboard and touchpad functionality. Put another way, the user may desire to depress keys while simultaneously moving objects on the display via the touchpad. Unfortunately, unless the userlmanufacturer completely disables KBACM and triggers other disadvantages, such simultaneous functionality is not available on current computing devices.

Aspects of the present disclosure address at least the above-mentioned issue by providing an approach that shrewdly balances ACM functionality with simultaneous keyboard and touchpad functionality. More particularly, aspects of the present disclosure provide a flexible ACM solution that allows simultaneous keyboard and touchpad use during some activities (e.g., gaming activities) while still providing strong ACM during other activities (e.g., non-gaming activities). This concept is discussed further below with reference to various figures and examples.

In one example implementation, a computing device includes a display, a touchpad, and a keyboard including a plurality of alphanumeric keys and a plurality of non-alphanumeric keys, where the plurality of alphanumeric keys include a first set of alphanumeric keys and a second set of alphanumeric keys. The computing device further includes a keyboard management module to (i) detect depression of one of the first set of alphanumeric keys for less than a first threshold time period and trigger KBACM with respect to the touchpad for a first time period; (ii) detect depression of one of the second set of alphanumeric keys for less than the first threshold time period and not trigger KBACM with respect to the touchpad; and (iii) detect depression of one of the plurality of alphanumeric keys for more than a second threshold time period and not trigger KBACM for a second time period.

In another example implementation, a process implemented by a computing device includes detecting, by a keyboard management module within the computing device. depression of one of a first set of alphanumeric keys for less than a threshold time period, and, in response, triggering KBACM with respect to a touchpad for a time period. The process further includes detecting, by the keyboard management module within the computing device, depression of one of a second set of alphanumeric keys for less than the threshold time period and, in response, not triggering KBACM with respect to the touchpad.

In yet another example implementation, a non-transitory machines-readable medium includes instructions, which when executed, cause a computing device to detect depression of one of a first set of alphanumeric keys for less than a threshold time period and, in response, trigger KBACM with respect to a touchpad for a time period. The instructions further cause the computing device to detect depression of one of a second set of alphanumeric keys for less than the threshold time period, and, in response, not trigger KBACM with respect to the touchpad.

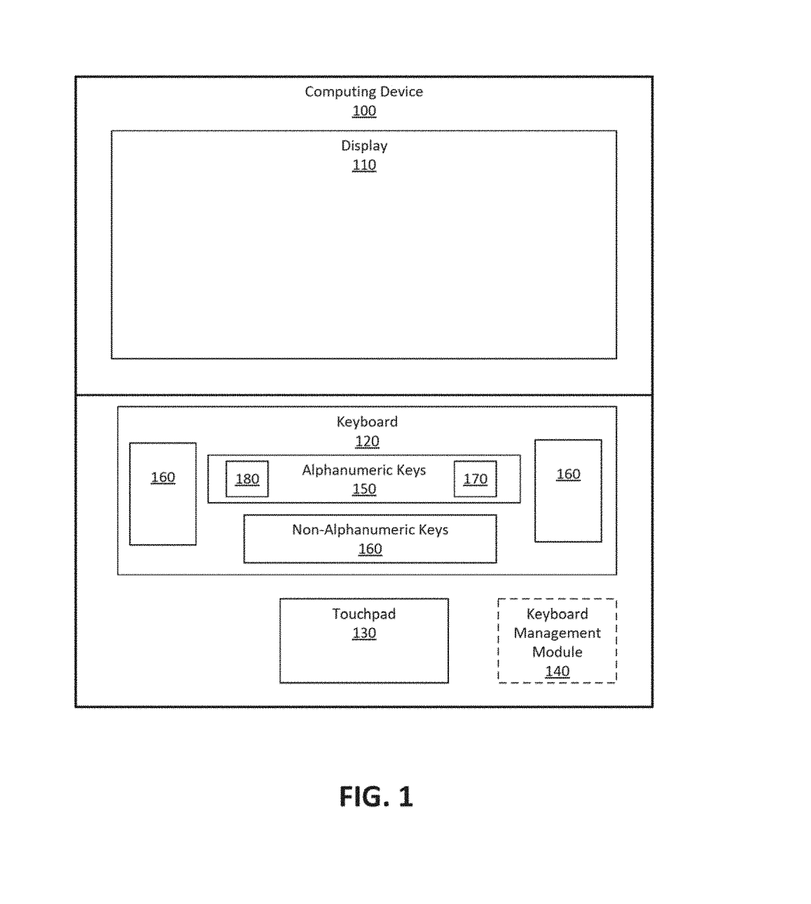

Looking now at FIG. 1, this figure depicts an example computing device 100 in accordance with an implementation. The computing device 100 may comprise, for example, a notebook, detachable notebook/tablet, a smart keyboard, or another computing device that includes a keyboard and touchpad. As shown, the computing device 100 includes a display 110, keyboard 120, touchpad 130, and keyboard management module 140. It should be understood that the figure depicts one example implementation, and various components may be added, removed, or modified in accordance with various other implementations without departing from the scope of the present disclosure.

The display 110 is to present content to a user. The display 110 may comprise, for example, a liquid crystal display (LCD), light emitting diode display (LED), organic light emitting diode display (OLED), active matrix organic light emitting diode display (AMOLED), retina display, or another display arranged to present content to a user. In some examples, the display 110 comprises a touchscreen layer to detect user touches, taps, and/or gestures (e.g., a resistive or capacitive touchscreen layer).

The keyboard 120 is to trigger input commands to the computing device 100. More specifically, the keyboard 120 comprises a plurality of keys that trigger commands when depressed. The keyboard 120 comprises a plurality of alphanumeric keys 150 that are associated with letters and/or numbers (e.g., the “W” key, the “L” key, and the “4” key). The keyboard 120 further comprises a plurality of non-alphanumeric keys 160 that are not associated with letters and/or numbers and are instead associated with functions, punctuation, or controls (e.g., the spacebar key, the tab key, the cursor control keys, the delete key, the page up key, and the “F1” key).

The touchpad 130 is to trigger input commands to the computing device 100 in response to a user touching, tapping, and/or moving a finger on a surface of the touchpad 130. This touching, tapping, and/or moving may cause, for example, movement of a cursor presented on the display 110. The touchpad 130 may include a tactile sensor to detect the position and/or movement of the user's finger on the surface of the touchpad 130.

The keyboard management module 140 is to manage functionality associated with the keyboard 120 and/or touchpad 130. In some examples, the keyboard management module 140 comprises a non-transitory machine-readable medium (e.g., volatile or non-volatile memory) and a processing device (e.g., a central processing unit (CPU)). The non-transitory machine-readable medium includes instructions, which when executed by the processing device, cause the computing device 100 to conduct functionality described herein. In other examples, the keyboard management module 140 comprises a functionally equivalent circuit to cause the computing device 100 to conduct functionality described herein (e.g., an application specific integrated circuit (ASIC), programmable logic device (PLD), or programmable gate array (PGA)).

Among other things, the keyboard management module 140 balances ACM functionality with simultaneous keyboard and touchpad functionality. More precisely. the keyboard management module 140 provides a flexible ACM solution that allows simultaneous keyboard and touchpad use during some activities (e.g., gaming activities) while still providing strong ACM during other activities (e.g., non-gaming activities). This may be accomplished by distinguishing depression of alphanumeric keys commonly associated with gaming activities (e.g., the “W” alphanumeric key. the “A” alphanumeric key, the “S” alphanumeric key, and the “D” alphanumeric key) from depression of those not commonly associated with gaming activities (e.g., the “P” alphanumeric key, the “O” alphanumeric key. the “I” alphanumeric key, and the “U” alphanumeric key). The depression of keys not associated with gaming activities triggers KBACM for a time period, whereas the depression of keys associated with gaming activities do not trigger KRACM. Hence, if a user is typing normally, KBACM will likely be triggered because at least one non-gaming key will likely be depressed during normal typing. By contrast, if the user is playing fames using the common movement keys (e.g., “W,” “A,” “S,” and “D”), KBACM will not be triggered and the touchpad can be used simultaneously for additional functionality.

In one example, the keyboard management module 140 is to detect depression of one of the first set of alphanumeric keys 170 (e.g., non-gaming keys) for less than a first threshold time period (e.g., <0.3 s) and trigger KBACM with respect to the touchpad 130 for a first time period (e.g., Is). The keyboard management module 140 is further to detect depression of one of the second set of alphanumeric keys 180 (e.g., gaming keys) for less than the first threshold time period (e.g., <0.3 s) and not trigger KBACM with respect to the touchpad. As a result, when the user is utilizing the second set of alphanumeric keys 180 for gaming activities, KBACM is not triggered and the user may utilize touchpad functionality at the same time as keyboard functionality. By contrast, when the user is utilizing the first set of alphanumeric keys 170 for non-gaming activities, KBACM is triggered and the user may not utilize touchpad functionality at the same time as keyboard functionality.

In some implementations, the keyboard management module 140 is to detect depression of one of the plurality of alphanumeric keys 150 for more than a second threshold time period (>0.9 s) and not trigger KBACM for a second time period (2 s). Thus, if a user is holding a key down for an extended time period (e.g., one of the second set of alphanumeric keys 180), KBACM is not triggered a second time period. This second time period may extend for a time period after the user releases the key (e.g., is after the user releases the key). In some examples, depression of another key during the second time period does not trigger KBACM during the second time period. Hence, if a user is holding down the “D” key, depression of one of the first set of alphanumeric keys 170 during the second time period will not trigger KBACM.

As mentioned above, the second set of alphanumeric keys 180 may be associated with gaming functionality and the first set of alphanumeric keys 170 may be associated with non-gaming functionality. For example, the second set of alphanumeric keys 180 may comprise the common movement keys “W,” “A,” “S,” and “D,” as well as some other popular gaming keys like “Q,” “E,”, “R,” “1,” “2,” “3,” “4,” and/or “5.” And the first set of alphanumeric keys 170 may comprise the remaining alphanumeric keys.

In some implementations, the keyboard management module 140 is further to provide an Interface on the display 110 to enable configuration of the first set of alphanumeric keys 170 and the second set of alphanumeric keys 180. In some examples, this configuration enables a user/manufacturer to set which keys are included in the first set of alphanumeric keys and which keys are included in the second set of alphanumeric keys. Alternatively or in addition, this configuration enables a user/manufacturer to set the duration of the above-discussed first time period and/or second time period. Alternatively or in addition, this configuration enables a user/manufacturer to enable/disable KBACM functionality for the plurality of alphanumeric keys and/or for the plurality of non-alphanumeric keys.

With regard to KBACM, in various implementations, when KBACM is not triggered (e.g., in response to depression of the second set of alphanumeric keys 180), palm rejection functionality persists. That is, even though KBACM is not triggered, the computing device 100 continues to detect and disregard touchpad input determined to be from a user's palm.

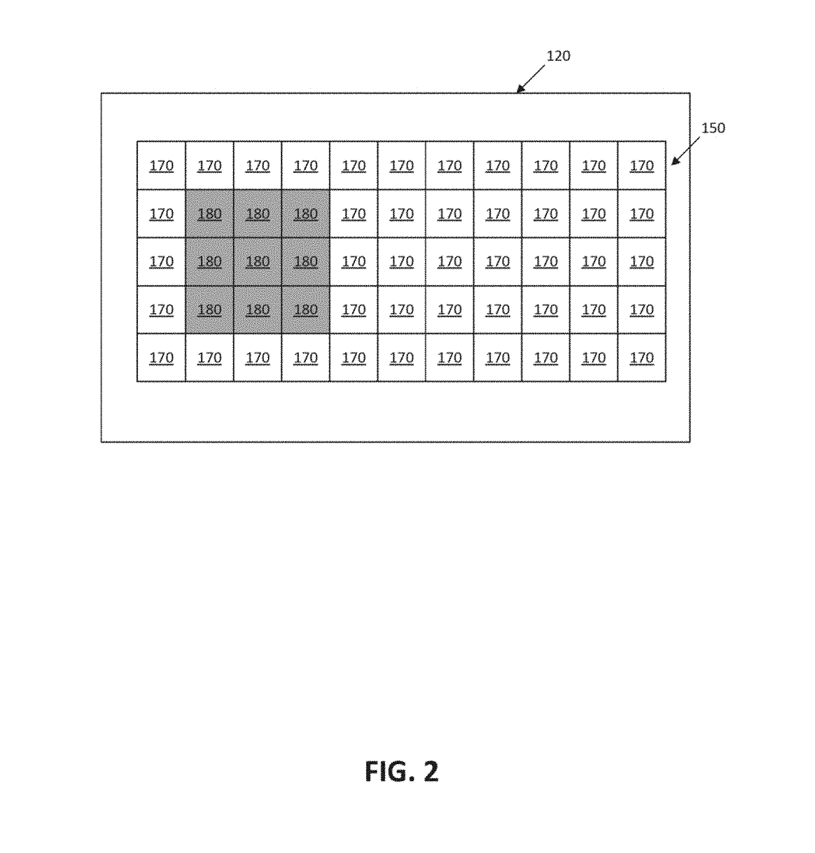

Turning now to FIG. 2. this figure depicts an example keyboard 120 configuration in accordance with an implementation. More particularly, the FIG. 2 depicts a keyboard 120 with a plurality of alphanumeric keys 150. The plurality of alphanumeric keys 150 comprise a first set of alphanumeric keys 170 and a second set of alphanumeric keys 180. In one example, the first set of alphanumeric keys 170 are associated with non-gaming functions and the second set of alphanumeric keys 180 are associated with gaming functions. Moreover, in one example, depression of the first set of alphanumeric keys 170 triggers KBACM and depression of the second set of alphanumeric keys 180 does not trigger KBACM.

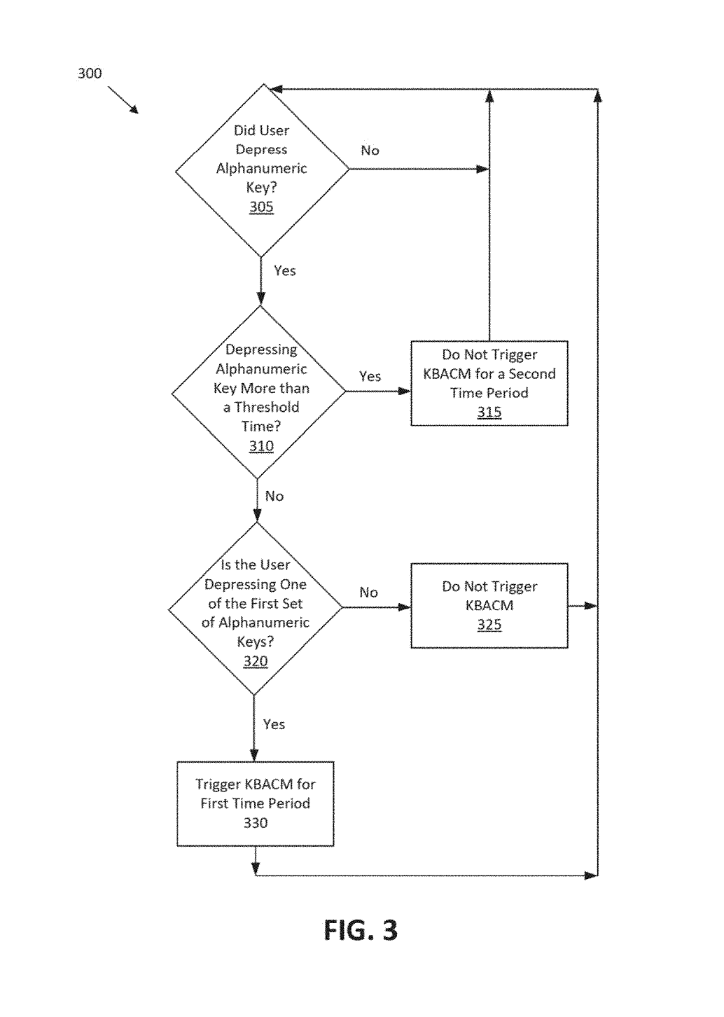

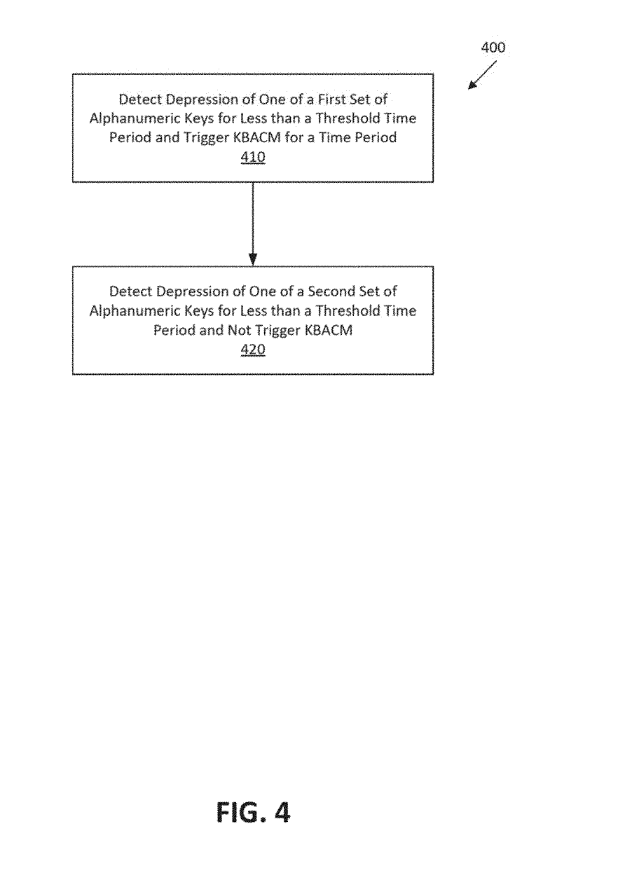

Turning now to FIG. 3, this figure depicts an example process flow diagram 300 for computing device 100 operation in accordance with an implementation. It should be should be readily apparent that the processes depicted in FIG. 3 (as well as FIG. 4) represent generalized Illustrations, and that other processes may be added or existing processes may be removed, modified, or rearranged without departing from the scope and spirit of the present disclosure. In addition, it should be understood that at least some of the processes depicted in FIG. 3 may represent instructions stored on a machine-readable storage medium that, when executed, cause a computing device 100 to respond, to perform actions, to change states, and/or to make decisions. Alternatively, at least some of the processes may be conducted by a functionally-equivalent circuit.

The process 300 may begin at block 305 where the keyboard management module 140 determines if an alphanumeric key 150 is being depressed. If an alphanumeric key 150 is being depressed, at block 310, the keyboard management module 140 determines whether the user is holding down the alphanumeric key 150. This may be accomplished by determining if the alphanumeric key 150 is being depressed for more than a threshold time period (e.g., >0.9 s). If it is determined that the user is holding down an alphanumeric key 150, at block 315, the keyboard management module 140 does not trigger KBACM for a second time period (e.g., 2 s). If, on the other hand, it is determined that the user is not holding down an alphanumeric key 150 (i.e., the user just tapped the key), at block 320, the keyboard management module 140 determines if the user is depressing one of the first set of alphanumeric keys 180 (e.g., non-gaming keys). If the user is depressing one of the first set of alphanumeric keys 180 (e.g., non-gaming keys), at block 330, the keyboard management module 140 triggers KBACM for a first time period. By contrast, if the keyboard management module 140 determines that the user is not depressing one of the first set of alphanumeric keys 180, then the user is necessarily depressing one of the second set of alphanumeric keys 170 (e.g., gaming keys). and therefore at block 325 the keyboard management module does not trigger KBACM. Hence, the process 300 provides a flexible ACM solution that allows simultaneous keyboard and touchpad use during some activities (e.g., gaming activities) while still providing KBACM during other activities (e.g., non-gaming activities).

Looking now at FIG. 4, this figure depicts an example process flow diagram 400 for computing device 100 operation in accordance with another implementation. The process 400 may begin at block 410 where, in response to detecting depression of one of a first set of alphanumeric keys (e.g., non-gaming keys), the computing device 100 triggers KBACM for a predetermined time period. Furthermore, at block 420, in response to detecting depression of one of a second set of alphanumeric keys (e.g., gaming keys), the computing device 100 does not trigger KBACM. As a consequence, the process 400 allows simultaneous keyboard and touchpad use during some activities (e.g., gaming activities) while still providing KBACM during other activities (e.g., non-gaming activities).

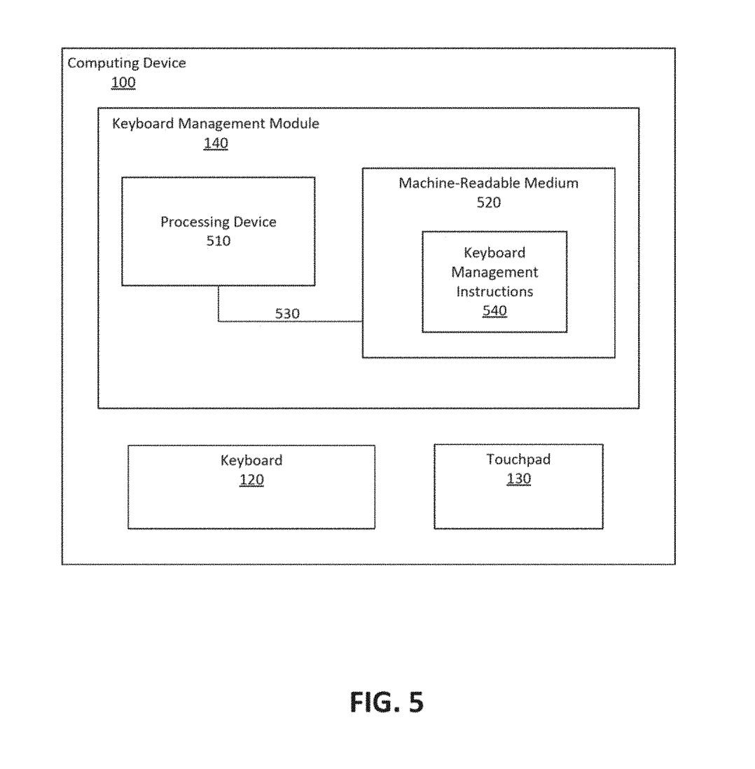

Turning now to FIG. 5, this figure depicts an example computing device 100 in accordance with another implementation. The computing device 100 comprises a keyboard 120. touchpad 130, and a keyboard management module 140. The keyboard management module 140 comprises a processing device 510 and a non-transitory machine readable medium 520 coupled via a communication bus 530. The processing device 510 is to retrieve and execute instructions stored on the machine-readable medium 520. Depending on the implementation, the processing device 510 may be a central processing unit (CPU), graphics processing unit (GPU), system-on-chip (SoC), or another processing device to retrieve and execute instructions. Put another way, the processing device 510 may fetch, decode, and execute instructions stored on the machine readable storage medium 520 to implement the functionalities described above and below.

The machine readable storage medium 520 may correspond to any typical storage device that stores machine-readable instructions, such as programming code, software, firmware, or the like. For example, the machine readable medium 520 may include one or more of a non-volatile memory, a volatile memory, and/or a storage device. Examples of non-volatile memory include, but are not limited to, electronically erasable programmable read only memory (EEPROM) and flash memory. Examples of volatile memory include, but are not limited to, static random access memory (SRAM) and dynamic random access memory (DRAM). Examples of storage devices include, but are not limited to, hard disk drives, compact disc read/write drives, digital versatile disc drives, optical read/write devices, and flash memory devices. The machine readable medium 520 comprises keyboard management instructions 540. The keyboard management instructions 540, when executed by the processing device 510, cause the computing device 100 to conduct the various functions discussed herein. For example, in one implementation, the keyboard management instructions 540 cause the computing device 100 to detect depression of one of a first set of alphanumeric keys for less than a threshold time period, and, in response, trigger KBACM with respect to the touchpad 130 for a time period. Moreover, the keyboard management instructions 540 cause the computing device 100 to detect depression of one of a second set of alphanumeric keys for less than the threshold time period, and, in response, not trigger KBACM with respect to the touchpad. As a result, the keyboard management instructions 540 enable simultaneous keyboard and touchpad use during some activities (e.g., gaming activities) while still providing KBACM during other activities (e.g., non-gaming activities).

The foregoing describes an approach that balances ACM functionality with simultaneous keyboard and touchpad functionality. More particularly, aspects of the present disclosure provide a flexible ACM solution that allows simultaneous keyboard and touchpad use during some activities while still providing strong ACM during other activities. While the above disclosure has been shown and described with reference to the foregoing examples, it should be understood that other forms, details, and implementations may be made without departing from the spirit and scope of the disclosure that is defined in the following claims.

What is claimed is:

1. A computing device, comprising:
a display;
a keyboard including a plurality of alphanumeric keys and a plurality of non-alphanumeric keys, wherein the plurality of alphanumeric keys include a first set of alphanumeric keys and a second set of alphanumeric keys;
a touchpad; and
a keyboard management module to
detect depression of one of the first set of alphanumeric keys for less than a first threshold time period and trigger keyboard-based accidental contact mitigation (KBACM) with respect to the touchpad for a first time period;
detect depression of one of the second set of alphanumeric keys for less than the first threshold time period and not trigger KBACM with respect to the touchpad; and
detect depression of one of the plurality of alphanumeric keys for more than a second threshold time period and not trigger KBACM for a second time period.

2. The computing device of claim 1, wherein the second set of alphanumeric keys are associated with gaming functionality.

3. The computing device of claim 1, wherein palm rejection functionality persists when KBACM is not triggered.

4. The computing device of claim 1, wherein the keyboard management module is further to provide an interface on the display to enable configuration of the first set of alphanumeric keys and the second set of alphanumeric keys, wherein the configuration comprises at least one of setting which keys are included in the first set of alphanumeric keys and which keys are included in the second set of alphanumeric keys.

5. The computing device of claim 1, wherein the keyboard management module is further to provide an interface on the display to enable configuration, wherein the configuration comprises at least one of setting the duration of the first time period and setting the duration of the second time period.

6. The computing device of claim 1, wherein the keyboard management module is further to provide an interface on the display, wherein the interface enables disabling and enabling KBACM for at least one of the plurality of alphanumeric keys and the plurality of non-alphanumeric keys.

7. The computing device of claim 1, wherein the second set of alphanumeric keys comprises at least the “W” alphanumeric key, the “A” alphanumeric key, the “S” alphanumeric key, and the “D” alphanumeric key.

8. The computing device of claim 1, wherein, if another one of the plurality of alphanumeric keys is depressed during the second time period, the keyboard management module does not trigger KBACM during the second time period.

9. A method, comprising:
detecting, by a keyboard management module within a computing device, depression of one of a first set of alphanumeric keys for less than a threshold time period, and, in response, triggering keyboard-based accidental contact mitigation (KBACM) with respect to a touchpad for a time period; and
detecting, by the keyboard management module within the computing device, depression of one of a second set of alphanumeric keys for less than the threshold time period, and, in response, not triggering KBACM with respect to the touchpad,
wherein the first set of alphanumeric keys are different from the second set of alphanumeric keys.

10. The method of claim 9, further comprising:
detecting, by the keyboard management module within the computing device, depression of at least one of the first and second set of alphanumeric keys for more than a second threshold time period and not triggering KBACM for a second time period.

11. The method of claim 10, wherein, if another one of the plurality of alphanumeric keys is depressed during the second time period, the keyboard management module does not trigger KBACM during the second time period.

12. The method of claim 9, further comprising:
triggering, by the keyboard management module, palm rejection functionality, wherein the palm rejection functionality persists when KBACM is not triggered.

13. A non-transitory machine-readable medium comprising instructions, which when executed, cause a computing device to:
detect depression of one of a first set of alphanumeric keys for less than a threshold time period, and, in response, trigger keyboard-based accidental contact mitigation (KBACM) with respect to a touchpad for a time period;
detect depression of one of a second set of alphanumeric keys for less than the threshold time period, and, in response, not trigger KBACM with respect to the touchpad,
wherein the first set of alphanumeric keys are different from the second set of alphanumeric keys, and
wherein the second set of alphanumeric keys comprises at least the “W” alphanumeric key, the “A” alphanumeric key, the “S” alphanumeric key, and the “D” alphanumeric key.

14. The non-transitory machine-readable medium of claim 13, wherein the non-transitory machine-readable medium comprises further instructions, which when executed, cause the computing device to detect depression of at least one of the first and second set of alphanumeric keys for more than a second threshold time period and not trigger KBACM for a second time period.

15. The non-transitory machine-readable medium of claim 13, wherein the non-transitory machine-readable medium comprises further instructions, which when executed, cause the computing device to trigger palm rejection functionality, wherein the palm rejection functionality persists when KBACM is not triggered.
